(19) United States
(12) Patent Application Publication
(10) Pub. No.: US 2013/0091556 A1
(43) Pub. Date: Apr. 11, 2013

(54) METHOD FOR ESTABLISHING A SECURE AND AUTHORIZED CONNECTION BETWEEN A SMART CARD AND A DEVICE IN A NETWORK

(71) Applicants: Guenther Horn, Munich (DE); Wolf Dietrich Moeller, Munich (DE)

(72) Inventors: Guenther Horn, Munich (DE); Wolf Dietrich Moeller, Munich (DE)

(73) Assignee: NOKIA SIEMENS NETWORKS OY, Espoo (FI)

(21) Appl. No.: 13/703,985

(22) PCT Filed: Jun. 21, 2010
(86) PCT No.: PCT/EP2010/058749

§ 371 Date: Dec. 13, 2012

(51) Int. Cl. H04L 29/06

(52) U.S. Cl. CPC H04L 63/0876
USPC 726/4

(57) ABSTRACT

It is provided a method a method for establishing a first secure and authorized connection between a smart card and a first device in a network, wherein the first device comprises a second secure connection to a second device, wherein the method comprises storing a first security data; transferring the first security data between the first device and the second device; providing the first security data at the first device; establishing a binding between the smart card and the first device via the first secure and authorized connection utilizing the first security data; authorizing the binding between the smart card and the first device; and sending a second security data from the smart card to the first device via the first secure and authorized connection whereas the second security data may be usable for authentication of the first device to the network.

### TECHNICAL FIELD

Embodiments of the present invention relate generally to mobile communications and more particularly to network devices and methods in communications networks. The invention relates to a method for establishing a secure and authorized connection between a smart card and a first device in a network. Moreover, the invention relates to devices within a network, to a smart card, to a computer program product and to a computer-readable medium.

### BACKGROUND

Enhancements of the Evolved Packet System (EPS), in particular Relay Node Architectures may comprise security aspects. Currently 3GPP is in the process of defining an enhancement to EPS that introduces so-called Relay Nodes (RNs) into the EPS architecture. An EPS architecture including RNs is also called a (EPS) Relay Node Architecture. A particular EPS Relay Node Architecture has been selected by 3GPP for further elaboration. This selected architecture is documented in 3GPP TR 36.806, where it is called “alternative 2”. An overview of this architecture is given in FIG. 4.2.1.1-1 of TR 36.806 v2.0.0, which is explained in the following and which is illustrated in FIG. 1.

An Relay Node (RN) may be a base station that relays traffic between a User Equipment (UE) and another base station, the donor base station. A base station in EPS may be called eNB, therefore the donor base station is abbreviated as DeNB. Both the Uu interface between the UE and the RN and the Un interface between the RN and the DeNB may be radio interfaces. Uu and Un may be similar. Uu between a UE and an eNB in an EPS architecture without relay nodes may be identical to Uu between a UE and an RN, i.e. the UE may be not aware of the presence of the RN.

An RN may have two faces: towards the UE the RN may act as an eNB; and towards the (rest of) the network the RN may act like a UE. The UE characteristics of an RN come into play in particular when the connections over the radio interface Un are established during the so-called RN start-up phase. The RN may attach to the network, and the radio bearers on Un between the RN and its DeNB may be established in the same way in which a UE attaches to the network and establishes radio bearers over the Uu interface between the UE and an eNB.

Consequently, there may be an MME that sees the RN in its role as a UE and the MME may be active in particular during the RN start-up phase. This MME is called the Relay UE's MME, or MME-RN for short. The MME-RN may authenticate the RN during the start-up phase and interacts with the HSS for this purpose. The HSS may contain the subscription data of the RN in its UE-role. Like a proper UE, the RN may also comprise a USIM on a UICC to enable authentication. In order to distinguish this USIM and UICC from the ones inserted in a UE, they may be named USIM-RN and UICC-RN (not shown in FIG. 1). Security keys for protecting signaling and user plane on the Un interface and for protecting NAS signaling between RN and MME-RN may be derived as defined for EPS without relay nodes.

The introduction of relay nodes into the EPS architecture may also create new security challenges. Thus, there may be a need to provide secure connections between a smart card or an USIM and a device within the network.

### SUMMARY OF THE INVENTION

According to an exemplary embodiment of the present invention a method may be provided, for establishing a first secure and authorized connection between a smart card and a first device in a network, wherein the first device may comprise a second secure connection to a second device. The method may comprise storing a first security data, transferring the first security data between the first device and the second device, providing the first security data at the first device, establishing a binding between the smart card and the first device via the first secure and authorized connection utilizing the first security data, authorizing the binding between the smart card and the first device, and sending a second security data from the smart card to the first device via the first secure and authorized connection, whereas the second security data may be usable for authentication of the first device to the network.

A secure connection may be a communication channel which is integrity protected and/or confidentiality protected and/or provides proof of origin of the transmitted data. An authorized connection may be a connection where at least one of the endpoints, or a third party, for example a MME-RN, gaining knowledge of the connection establishment, has taken a decision that the connection is allowed to be established or used where this decision is based on some authorization data which may be stored locally in at least one of the endpoints or may be received by at least one of the endpoints from some other entity, or may be stored at or received by the third party.

A secure and authorized connection may be a combination thereof. “Secure and authorized connection” is often also called “secure channel” within this context and in the following text.

A smart card may be understood as a module with an embedded integrated circuit (IC) which provides a medium for storing and transporting information, for example SIM cards or UICC cards are smart cards. Smart cards may comprise applications such as USIM applications (also called “USIM” for short in the following). The UICC may provide non-volatile storage for data, and a secure environment in which to store, execute and verify the results of cryptographic algorithms. The UICC may be either separable from a mobile equipment, or permanently embedded.

A method may be provided for mitigating attacks on the interface between a relay node and a UICC. The first device may be an RN. The second device may be an OAM server or Donor eNB. The security data may be stored at the second device.

It may be understood that first security data and second security data may be security data of any kind. It may be possible that the first security data differs from the second security data.

According to an exemplary embodiment of the present invention, the security data may be at least one security data from the group of data consisting of a pre-shared key, a certificate, a root certificate, certificate revocation data, authorization data, a serving network identity, a smart card identity, a network device identity, data generated from a run of EPS AKA, a transformed key of a preexisting key, at least one parameter derived from a certificate and an authorization message.

The mentioned security data may be the first and/or the second security data. An EPS AKA may be an authentication and key agreement (AKA) as for example defined in 3GPP TS 33.401, from Release 8 on.

According to an exemplary embodiment of the present invention, the method further may comprise storing a list of keys and/or authorization data for the smart card on the second device installed within the network.

According to an exemplary embodiment of the present invention, the method further may comprise generating security data dynamically at the second device or at a third device connected with the second device.

According to an exemplary embodiment of the present invention, the method further may comprise deriving the security data from parameters obtained during a run of EPS AKA authenticating the first device and/or from a device identity.

According to an exemplary embodiment of the present invention, the method further may comprise receiving a certificate or a root certificate at the first device originating from the second device.

According to an exemplary embodiment of the present invention, the method further may comprise providing integrity protection by digitally signing security data by a network device.

According to an exemplary embodiment of the present invention, the method further may comprise the first device sending its own identity and/or the identity of the smart card device to a fourth network device via the second device for authorization validation.

The second device may be a DeNB. The fourth network device may be an MME-RN.

According to an exemplary embodiment of the present invention, the method further may comprise the second device sending the identity of the first device and/or the identity of the smart card device to a fourth network device for authorization validation.

The second device may be a DeNB, and the fourth device may be an MME-RN: The DeNB may send the RN device identity to the MME-RN, and the MME-RN may check the RN device identity against the USIM identity reauthenticated for the purpose of checking that the binding of USIM and RN is authorised.

According to an exemplary embodiment of the present invention, it may be foreseen that the method comprises an authentication or a re-authentication of the first device to the network using EPS AKA security data received over the secure and authorized connection.

According to an exemplary embodiment of the present invention, it may be foreseen that the authentication may be performed by IPsec.

According to an exemplary embodiment of the present invention, it may be foreseen that the second device performs access control and/or platform validation of the first device to the network based on the result of one or multiple (re-)authentication(s).

The second device may be a DeNB.

According to an exemplary embodiment of the present invention, there may be provided a device in a network comprising a first interface, second interface and a third interface, wherein the first interface may be adapted to send and/or receive security data, wherein the second interface may be adapted to establish a binding towards a smart card via a first secure and authorized connection, and wherein the third interface may be adapted to establish a binding toward another device via a second secure connection.

According to an exemplary embodiment of the present invention, the network device may be at least one network device selected from the group of devices consisting of a relay node (RN), an USIM in a UICC connected to an RN (USIM-RN), an eNB, a donor eNB, a MME, a MME-RN, a relay, a server, an OAM server, a OCSP server, a home subscriber server (HSS), a AAA server, an identity manager and a data repository.

According to an exemplary embodiment of the present invention, the network device may comprise a first endpoint of a secure connection to the smart card and a second endpoint of a secure connection to a second network device, wherein the first endpoint and the second endpoint may terminate in a same trusted environment in the network device.

Thus, the endpoints of the secure connections to the smart card and a second network device respectively both may terminate in the same trusted environment in the first network device. This feature may be of advantage for example for an RN.

According to an exemplary embodiment of the present invention, there may be provided a smart card within a network, wherein the smart card may receive a device identity.

The device identity may be a security data.

According to an exemplary embodiment of the present invention, it may be foreseen that security data may be stored in the smart card and a transformation of the security data may be performed, using the device identity.

According to an exemplary embodiment of the present invention, there may be provided a smart card that may perform a certificate status check using the device identity of the first device.

The smart card may check the status of the certificate, for example of a RN.

According to an exemplary embodiment of the present invention, a computer program product may be provided comprising code portions for causing a device, on which the computer program may be executed, to carry out a method according to the present invention.

The exemplary embodiments of the present invention in relation to network devices may comprise a processor, which processor may be adapted to carry out the methods according to exemplary embodiments of the present invention. This processor may utilize the computer program product in order to perform the methods according to the present invention.

According to an exemplary embodiment of the present invention, the computer-readable medium may be provided embodying the computer program product according to the present invention.

According to an exemplary embodiment of the present invention the security keys for protecting signaling and user plane on the Un interface and for protecting NAS signaling between RN and MME-RN may be derived from two high-level keys called CK and IK. CK and IK may be generated in the USIM-RN during authentication and then sent from the USIM-RN to the RN. This procedure may be the same as for EPS without RNs where the USIM sends CK and IK to the Mobile Equipment (ME) during authentication. An attacker could now listen on the interface between UICC-RN and RN and obtain the keys CK and IK in this way. Consequently, the attacker would then be able to obtain the keys for protecting signaling and user plane on the Un interface and for protecting NAS signaling between RN and MME-RN. Using these keys, the attacker could then listen to all traffic on the Un interface or modify messages on the Un interface unless additional countermeasures were taken.

A description of possible security measures for protecting the Un interface is given in the 3GPP temporary documents 53-100447, S3-100656. S3-100447 does not address the problem of eavesdropping on the interface between UICC-RN and RN. However, the 3GPP temporary documents S3-100572 and S3-100573 point to a countermeasure against eavesdropping on this interface, namely the establishment of a secure channel between the UICC-RN and the RN, e.g. according to the ETSI standard TS 102484.

Thus, exemplary embodiments of the invention may provide in a way suitable for Relay Node architectures, the establishment of the security keys in the UICC on the one hand and the RN on the other hand that are required for setting up a secure channel between UICC-RN and RN and protecting data sent across this channel.

There may be provided some possibilities according to the ETSI standard TS 102484:

“To manage the security aspects of these secure channel protocols, Security Contexts are set up which contain security settings and key material. The present document defines four mechanisms to agree key material using:”
Strong Pre-shared Keys—GBA: Key material is agreed using the GBA procedures specified in TS 133 110. The UICC and the terminal shall support this mechanism if GBA is supported.

In relation to Strong Pre-shared Keys—GBA: the procedure may require additional functional entities in the network, namely a BSF and a NAF Key Centre, cf. TS 133 110 which is inferred from 3GPP TS 33.110. Furthermore, the procedure may require the run of additional procedures according to GBA and 3GPP TS 33.110, in particular an additional run of an authentication procedure over the so-called Ub interface between the RN and the BSF. Therefore, the use of this alternative may be complex.
Strong Pre-shared Keys—Proprietary Pre-agreed keys: These are keys with an entropy of at least 128 bits. The UICC and the terminal may support this mechanism.

In relation to Strong Pre-shared Keys—Proprietary Pre-agreed keys, the use of the word “proprietary” may be understood that the ETSI standard TS 102484 does not specify a method how to obtain these keys.
Weak Pre-shared Keys—Proprietary Pre-agreed keys: These are keys with an entropy of less than 128 bits (such as password based keys). The UICC and the terminal may support this mechanism.

In relation to Weak Pre-shared Keys—Proprietary Pre-agreed keys, such keys may be not acceptable from a security point of view.
Certificate exchange: A UICC or a terminal that does not support the GBA mechanism shall support this mechanism. A UICC or a terminal that does support the GBA mechanism may support this mechanism.”

In relation to Certificate exchange, this alternative may be an option to consider. However, it may entail the complexities implied in setting up and maintaining a public key infrastructure and distributing certificates to the involved entities. The ETSI standard TS 102484 may not comprise any method for distributing certificates, e.g. the required root certificates, to the involved entities.

Moreover, exemplary embodiments of the present invention may provide a method in order how the key establishment can be embedded in other security procedures during the RN start-up phase so that the combination of procedures may result in a secure transmission of data from the UE to the network across relay nodes.

There may be a need that a secure channel between the RN and an OAM server may be necessarily established during the RN start-up phase using e.g. TLS or IPsec.

There may be a need that an IPsec security association is set up between a secure environment on the RN and the DeNB during the RN start-up phase.

No solution may be provided regarding the combination of the secure channel method according to the ETSI standard TS 102484 on the one hand and the above-mentioned methods on the other hand. Thus, exemplary embodiments of the present invention may provide such solutions.

According to exemplary embodiments of the present invention there may be provided methods to establish “Strong Pre-shared Keys—Proprietary Pre-agreed keys:” using functional elements which may be already available in the relay node architecture selected by 3GPP.

According to a first exemplary embodiment of the present invention a method is provided which may use the secure channel between the RN and an OAM server to send a key to the RN that can be used as the strong pre-shared key between USIM-RN and RN. It is assumed that the OAM server holds a list of keys where each key is associated with one USIM-RN. This association may be the basis for the authorization to establish the secure channel between a certain RN and a certain UICC-RN. By sending the appropriate key the OAM server may implicitly transfer the authorisation information to the RN. This method requires the USIM to hold a pre-shared key (in addition to the pre-shared key used for authentication) which is an extension to the USIMs used normally. But the UICC would not have to be modified if it supports TS 102484 already. The establishment procedure for the secure channel between RN and OAM server may be done using existing mechanisms, e.g. TLS. This channel may be necessary anyhow for e.g. management purposes.

According to a second exemplary embodiment of the present invention a method is provided which may also use the secure channel between the RN and an OAM server to send a key to the RN that can be used as the strong pre-shared key between USIM-RN and RN. It is assumed, however, that the OAM server retrieves the key sent to the RN from another server, e.g. from the HSS via an Sh interface. The HSS may dynamically generate this key from CK, IK in the EPS authentication vector used in the initial EPS AKA during RN attachment. As an extension to the existing HSS functionality, this may require the HSS to keep the authentication vector used in the last successful authentication, or to generate the pre-shared key between USIM-RN and RN together with the authentication vector and store this key. The UICC may have to be modified so as not to give CK, IK to the RN, but only K_{ASME}, which would be sufficient for EPS procedures to work. For this purpose the RN would have to give the serving network identity to the USIM-RN so that it can derive the K_{ASME}. A key derived from CK, IK—and not CK, IK themselves as CK, IK must not leave the HSS—could serve as the pre-shared key in the sense of TS 102484.

This method may not need the additional pre-shared key as required in the method according to the first exemplary embodiment. In this exemplary embodiment the authorisation data may be stored locally in the OAM server, or the OAM server may receive the authorisation data from the HSS together with the retrieved key. The authorisation information may be transferred to the RN the same way as in the first exemplary embodiment.

According to a third exemplary embodiment of the present invention a method is provided which may use the IPsec tunnel between the RN and the DeNB to send a key to the RN that can be used as the strong pre-shared key between USIM-RN and RN. The DeNB may obtain this key from the MME-RN over S1-RN. The MME, in turn, may obtain this key from the HSS. The HSS may generate this key as follows: when the MME-RN requests EPS AVs from the HSS that relate to a USIM-RN (recognizable from the special subscription type relating to relay nodes) then the HSS may obtain an AV from the AuC as normal, turns them into an EPS AV as described in TS 33.401 and send the EPS AV containing the key K_{ASME} to the MME-RN. K_{ASME} may be computed from CK, IK and the Serving Network identity. In addition, the HSS may compute another key, called EK_{ASME}. EK_{ASME} may be computed from CK, IK and further parameters. EK_{ASME} could be computed from CK, IK e.g. by including a parameter “for relay use” in the key derivation. A further key derivation from EK_{ASME} for the key Ksc used for the secure channel could then be performed in either the HSS or (preferred) in the MME-RN. This further key derivation may include e.g. the RN id (base station identity). The RN id may be known to the MME-RN, but may be not known to the HSS. Thus within the EPS procedures the RN may correspond to the ME in ordinary EPS procedures, so a device identity may be included in the key derivation.

This method also may require the UICC not to give CK, IK to the RN, but only K_{ASME}, for the same reasons as in the second method described above. The third exemplary embodiment of the method may not need the additional pre-shared key as foreseen in the first exemplary embodiment. In this exemplary embodiment the authorisation data may be stored in the HSS and may be retrieved by the MME-RN together with the retrieved key. By sending the appropriate key the MME-RN may transfer the authorisation information to the RN via the DeNB.

According to a fourth exemplary embodiment of the present invention a method is provided which may establish certificates used in a “Certificate exchange” using functional elements already available in the relay node architecture selected by 3GPP. The basic setting of this method (to establish a secure channel between RN and USIM-RN based on certificates) may be performed as already known. Moreover, the method may use the secure channel from RN to OAM server.

This fourth exemplary embodiment of the method may use the secure channel between the RN and an OAM server to send a certificate to the RN by which the RN can set up a secure channel with the USIM-RN according to TS 102484. This may apply if e.g. the RN is not provided with a root certificate to be able to validate the certificate of the USIM-RN. In particular, the following may be foreseen: the USIM-RN may send its identity to the RN when USIM-RN and RN start to communicate. Alternatively or in addition, the USIM-RN may send a certificate to the RN. Then the RN may send the USIM-RN identity, or relevant parts thereof or parameters derived from it, or the certificate from the USIM-RN, or relevant parts thereof or parameters derived from it, to the OAM server over the secure channel. The OAM server may respond with a corresponding certificate, e.g. a root certificate required to verify the certificate of the USIM-RN. The OAM server could also act as an OCSP server. It may be foreseen that the RN may have already performed the certificate enrolment procedures for base stations according to 3GPP TS 33.310, and may hence be in possession of a certificate which could be used for setting up the secure channel with the USIM-RN. The root certificates for the certificate in the RN and the certificate in the USIM often may be, but may not need necessarily be, the same.

Moreover, the OAM server may provide the RN with authorisation data for establishing the secure channel with the USIM-RN. By a validation of the USIM-RN certificate against the root certificate the RN may determine that the USIM-RN possesses a certificate issued under the policies of the root CA. The transferred authorisation data may give the allowed identity or list of identities of USIM-RNs, or allowed attributes of the USIM-RN certificates.

Furthermore, the OAM server may send authorisation data to the USIM-RN via the secure channel between OAM server and RN. The RN then may forward this authorisation data to the USIM-RN. The security requirements on this authorisation data may depend on the threat scenario; (a) if the RN is trusted and if the secure channel can be established without this authorisation data, then there may be no need to secure such authorisation data as hop-by-hop security is given, and the USIM-RN may rely on the integrity of the data. (b) if the two pre-conditions of (a) are not fulfilled, the authorisation data may be integrity and replay protected and may be confidentiality protected. Integrity protection could be achieved e.g. by the OAM server digitally signing the data. The USIM-RN would then have to be in possession of the corresponding certificate allowing the verification of the digitally signed data. By this authorisation data the USIM-RN may e.g. be informed to which RN it is allowed to connect. Another option would be sending securely a root certificate to the USIM-RN if it is not provided with a root certificate for validation of the RN certificate. The latter option may require that the USIM-RN has a trust anchor provisioned which may allow the validation of the authorisation message from OAM server.

In relation to the first, second, third and fourth exemplary embodiment providing a method, for all these methods it may be foreseen the following aspects, respectively:

After establishment of the secure channel with the UICC the RN may establish or re-establish a secure connection or a secure channel with the DeNB, e.g. using EPS AKA, using security data sent by the UICC through the secure channel. Alternatively, or additionally, the RN may establish a secure channel with the DeNB, e.g. using IPsec, based on some security data stored in the RN, with the precondition that the RN passed an internal integrity check before the establishment of the secure channel with the UICC and subsequently successfully established the secure channel with the UICC. By binding the authentication with the DeNB based on security data received through the secure channel to the UICC with the authentication based on the security data stored in the RN and only performed after successful integrity check of the RN, the RN may signal to the DeNB that it is authenticated and integrity checked. The DeNB may base access control of the RN to the network on this signalling.

Thus, exemplary embodiments of the present invention may provide a solution how the RN may obtain keying material and authorization data in order to protect the interface between the RN-UICC and the RN. Such keying material may be utilized in order to establish a secure channel between the entity holding the UICC in the RN and the RN entity. Crypto keys, such as CK, IK within the RN may be protected from malicious interception and/or manipulation, wherein the CK, IK crypto keys may be utilized to protect the Uu interface between the UE and the RN. Thus, exemplary embodiments of the invention may combine secure channel techniques with key management techniques. These may be utilized for example in the specific context of RN interfaces, so that for the RNs and their components such as UICC-RN and RN-platform security protection may be established. Moreover, there may be provided a strong pre-shared key establishment as well as an IKE-based or TLS-based key management.

### BRIEF DESCRIPTION OF THE DRAWINGS

Embodiments of the present invention are described below with reference to the accompanying drawings, which are not necessarily drawn to scale, wherein:

FIG. 1 illustrates a network architecture according to an exemplary embodiment;

FIG. 2 illustrates a method according to a first exemplary embodiment of the present invention;

FIG. 3 illustrates a method according to a second exemplary embodiment of the present invention;

FIG. 4 illustrates a method according to a third exemplary embodiment of the present invention;

FIG. 5 illustrates a method according to a fourth exemplary embodiment of the present invention;

FIG. 6 illustrates a first exemplary embodiment of a network architecture comprising a smart card; and

FIG. 7 illustrates a second exemplary embodiment of a network architecture comprising a smart card.

### DETAILED DESCRIPTION

The illustration of the drawings is schematic. In different drawings, similar or identical elements are provided with the same reference numerals.

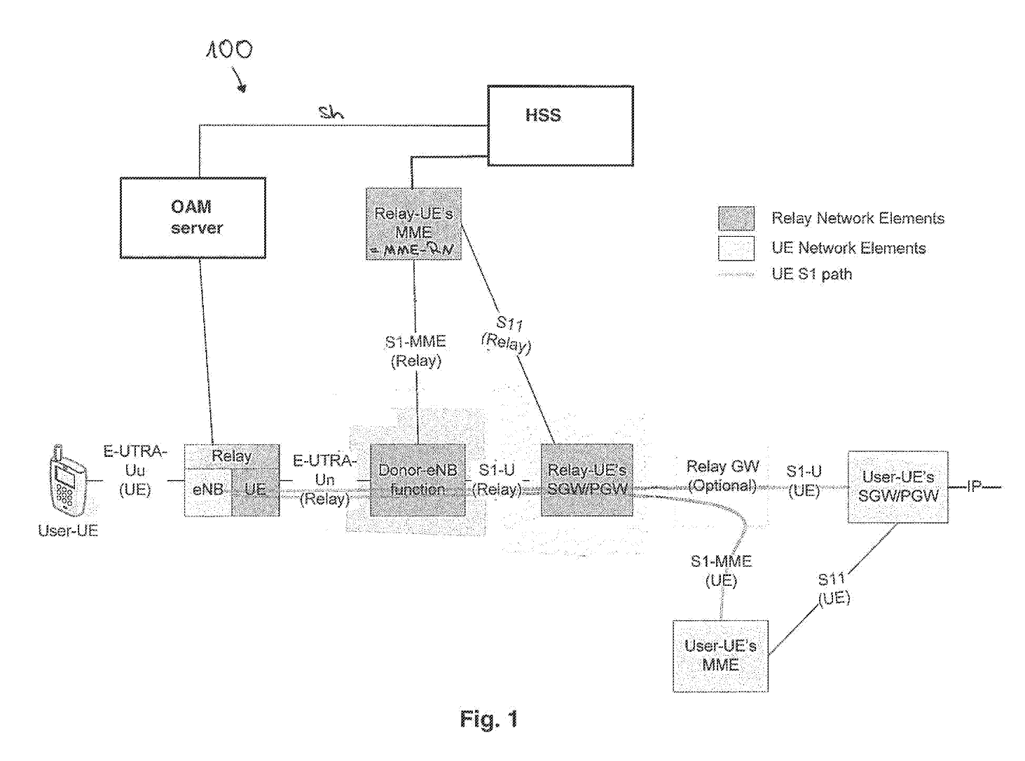

FIG. 1 illustrates a relay node architecture within a 3GPP environment as already described above. A network 100 comprises a User UE or UE, a Relay Node (RN), a DeNB, a SGW/PGW, a Relay GW, a MME, a Relay-UE's MME or MME-RN, an OAM server and an HSS. Moreover interfaces between network devices are illustrated respectively, such as Uu-interface, S1-MME-interface, Un-interface, S11-interface, S1-U-interface and Sh-interface.

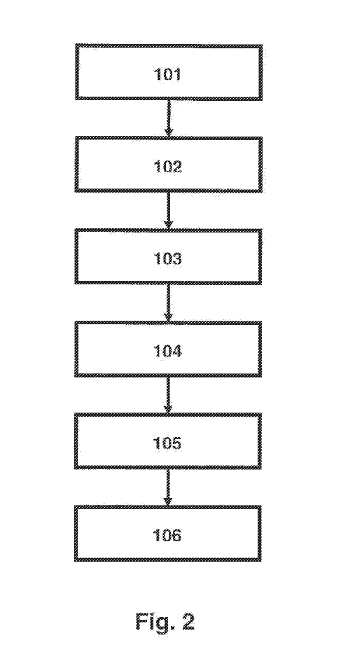

FIG. 2 illustrates a method according to a first exemplary embodiment of the present invention. In step 101 the RN attaches to the network using any eNB. The communication between USIM-RN and RN may be not secured. The authentication may be performed by the MME-RN.

In step 102 the secure channel between the RN and the OAM server may be established and further necessary configuration steps may be performed.

In step 103 the OAM server sends a key to the RN that can be used as the strong pre-shared key between USIM-RN and RN. This is either a key stored in the OAM server and related to the USIM-RN, or the key is derived from such a key stored in the OAM server. The derivation comprises e.g. the RN identity.

In step 104 the USIM-RN and the RN set up a secure channel between them, this may be done according to TS 102484. The USIM uses its stored pre-shared key for secure channel establishment. If the OAM server sent a derived key, the USIM-RN may have to perform the same derivation.

In step 105 the RN reattaches to the network, now via the DeNB, and is reauthenticated in the process. CK, IK is sent over the interface between USIM-RN and RN can not be read by the attacker as the interface is protected.

In case the RN attaches to the DeNB already in step 101, only a reauthentication may be performed for the existing connection. In step 106 the IPsec tunnel between RN and DeNB may be established. Steps 105 and 106 may be switched if the RN attaches to the DeNB already in step 101.

This method may provide several advantages: The ordinary case for pre-shared keys would be that both parties have to be provisioned with these keys beforehand. The method may provide this only for the USIM-RN. The pre-shared key in the RN may be configured remotely and dynamically by the network (represented by the OAM server) via the secure channel between OAM server and the RN. This may allow changing the binding relations between USIM-RN and RN dynamically without the need to locally manage the RN. Only the data base in OAM server may have to be adapted.

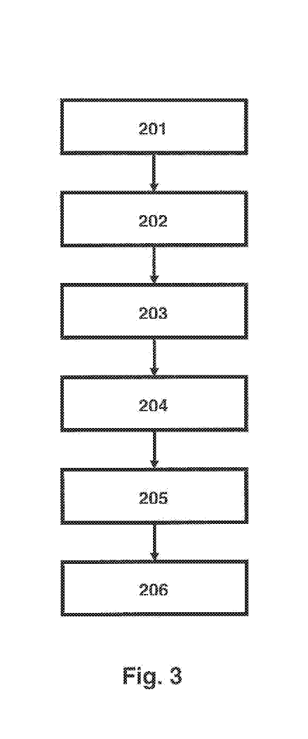

FIG. 3 illustrates a method according to a second exemplary embodiment of the present invention. In step 201 the RN attaches to the network using any eNB. The communication between USIM-RN and RN may be not secured. The authentication may be performed by the MME-RN.

In step 202 the secure channel between the RN and the OAM server may be established and further necessary configuration steps may be performed.

In step 203 the OAM server may retrieve a suitable key from the HSS. The OAM server then sends a key to the RN that can be used as the strong pre-shared key between USIM-RN and RN. This key is derived from the key retrieved from the HSS. The derivation may comprise e.g. the RN identity.

In step 204 the USIM-RN and the RN set up a secure channel between them, which may be foreseen according to TS 102484. This may require the USIM-RN to internally perform the same derivations as done in HSS and OAM server. The USIM may have no need to store a pre-shared key, but may use CK, IK of the last successful authentication as input for derivation of the pre-shared key.

In step 205 the RN reattaches to the network, now via the DeNB, and is reauthenticated in the process. CK, IK sent over the interface between USIM-RN and RN can not be read by the attacker as the interface is protected. In case the RN attaches to the DeNB already in step 201, only a reauthentication may be necessary for the existing connection.

In step 206 the IPsec tunnel between RN and DeNB may be established. Steps 205 and 206 may be switched if the RN attaches to the DeNB already in step 201.

This method may provide several advantages: In addition to the advantages of the first exemplary embodiment of a method, with the present, there may be no need to pre-provision the USIM-RN with a pre-shared secret. The pre-shared secret in USIM-RN may be dynamically generated from the last authentication procedure with the network, based on the shared key which exists in the USIM anyhow for authentication. It may be foreseen that the OAM server may need access to the HSS, which may require adaptations in the core network. Moreover, the USIM may be changed to that extent that the keys CK, IK are not directly transferred outside the UICC, but only the derived K_{ASME} is sent to RN for authentication. This may avoid that an attacker can also derive the pre-shared key used inside the USIM.

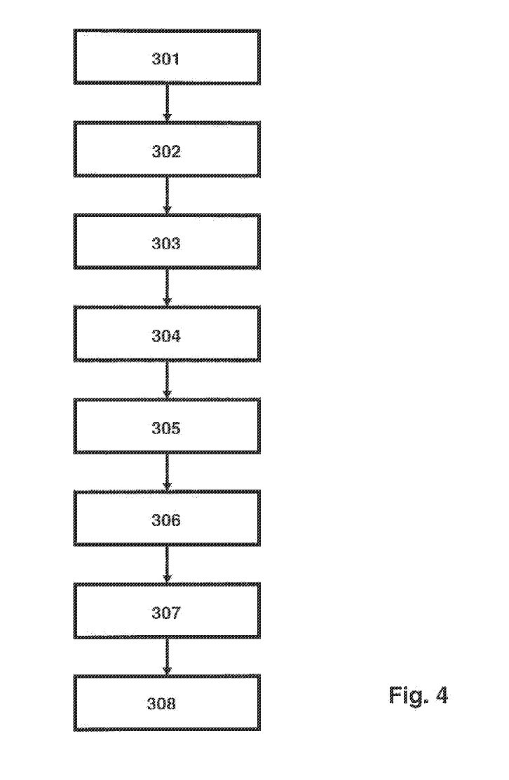

FIG. 4 illustrates a method according to a third exemplary embodiment of the present invention. In step 301 the RN may attach to the network using any eNB. The communication between USIM-RN and RN may be not secured. The authentication may be performed by the MME-RN.

In step 302 the secure channel between the RN and the OAM server may be established and further necessary configuration steps may be performed. It should be noted, that steps 301 and 302 may be omitted, since the secure channel to OAM server may not be utilized in this method. In this case the RN may attach to the DeNB as described in step 303.

In step 303 it may be foreseen that in case the RN did not attach to the DeNB already in step 301, the RN may attach now to the DeNB and may be authenticated in the process.

In step 304 the MME-RN may retrieve EK_{ASME} from the HSS, together with the authentication vector used in step 303 (or in step 301, if step 303 is omitted). The MME-RN may derive the key Ksc from EK_{ASME} and may send it to the DeNB in an appropriate S1-AP message, e.g. an extended S1 UE INITIAL CONTEXT SETUP message.

In step 305 the IPsec tunnel between RN and DeNB may be established.

In step 306 the DeNB may send the key Ksc via the IPsec tunnel created in step 305 to the RN. Alternatively the key Ksc may be sent during the execution of the IPsec tunnel establishment in step 305, and Ksc is transferred securely within e.g. an IKEv2 message, e.g. in the Notify Payload of an IKE_RUTH response.

In step 307 the USIM-RN and the RN set up a secure channel between them, for example according to TS 102484, using the key Ksc as a pre-shared key.

In step 308 the RN is reauthenticated and a key change on the fly is performed, for example according to 3GPP TS 33.401. Thus, K_{ASME} sent over the interface between USIM-RN and RN may not be read by the attacker as the interface is protected.

This method may provide several advantages: This method is similar to the second exemplary embodiment as described above. However, the present method may use different communication channels and network elements and may have thus different impact on the core network. It is an advantage that there might be no new interface needed (between OAM server and HSS), and that the OAM connection may not be changed and/or may not be present. This means that the present method may be applied also when no OAM connection is necessary for initial configuration on attachment of the RN to DeNB. Instead of requiring the interface between OAM server and HSS, the existing signalling path from HSS via MME to DeNB may be used, and also the existing security measures for these connections (i.e. IPsec on the backhaul between DeNB and MME) may be used. The present method may influence adaptations of functionalities and interfaces in the core network.

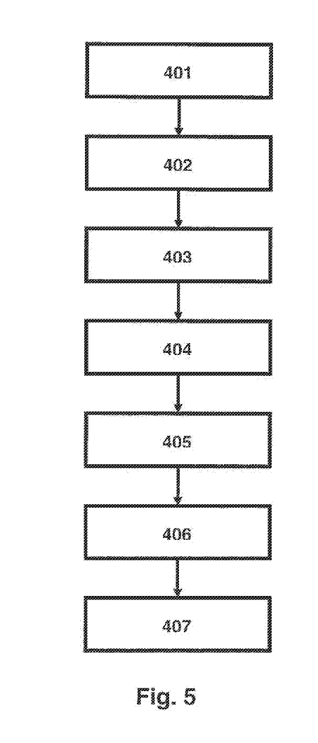

FIG. 5 illustrates a method according to a fourth exemplary embodiment of the present invention. In step 401 the RN attaches to the network using any eNB. The communication between USIM-RN and RN may be not secured. The authentication may be performed by the MME-RN.

In step 402 the secure channel between the RN and the OAM server may be established and further necessary configuration steps may be performed.

In step 403 the OAM server may send any data necessary as described above in the fourth exemplary embodiment comprising certificates, root certificates, certificate status report, USIM-RN identities, or authorisation data to the RN via the secure channel.

In step 404 the USIM-RN and the RN set up a secure channel between them, for example according to TS 102484.

In step 405 the RN sends any data as described above in the fourth exemplary embodiment comprising any of the data from step 403 and targeted to the USIM-RN to the USIM-RN. If this data is secured, e.g. by a signature of the network, such data may also be sent to the USIM-RN before between steps 403 and 404.

In step 406 it is foreseen that in case the RN did not attach to the DeNB already in step 401, the RN attaches now to the DeNB and is reauthenticated in the process. K_{ASME} sent over the interface between USIM-RN and RN can not be read by the attacker as the interface is protected.

In step 407 the DeNB may send the RN device identity to the MME-RN, and the MME-RN will check the RN device identity against the USIM identity reauthenticated in step 406 for the purpose of checking that the binding of USIM and RN is authorised. With other words, it may be foreseen that the DeNB sends the identity of the RN to a further network device for authorization validation, which further network device may be the MME-RN.

This method may provide several advantages: The method may allow dynamic management of trust anchors, credentials and authorisation data using a secure connection between OAM server and RN which is deployed in many cases for initial configuration of a RN before actual operation as RN. The method may have no impact on the core network, apart from the OAM server, if step 407 is optionally not performed.

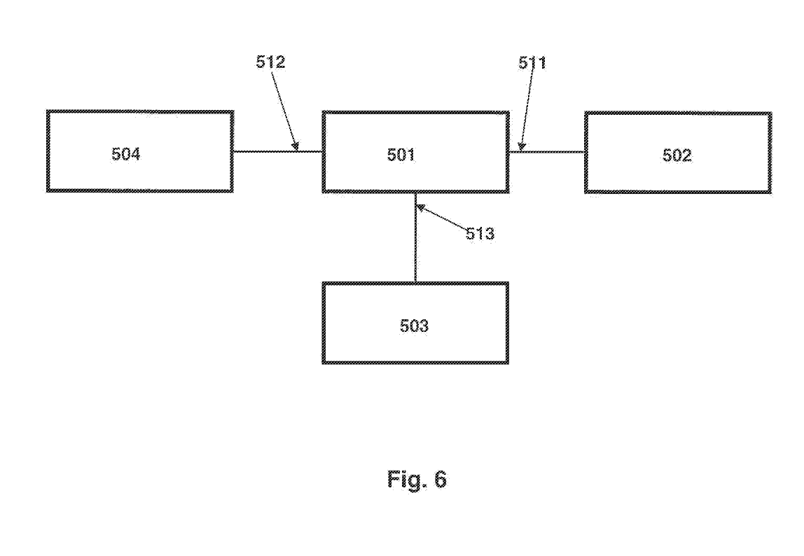

FIG. 6 illustrates a first exemplary embodiment of a network architecture comprising a smart card 504. The network comprises a first device 501, which is a RN and a second device 502, which is an OAM server. The RN comprises a first interface 511, a second interface 512 and a third interface 513. The RN 501 is connected to a smart card 504 via the second interface 512. The RN 501 is connected with the OAM 502 via the first interface 511. Moreover, the RN 501 is connected with a DeNB 503 via the third interface 513.

The first interface may provide TLS. The second interface may establish a binding using a secure channel and the third interface may provide a secure link between the RN 501 and the DeNB 503.

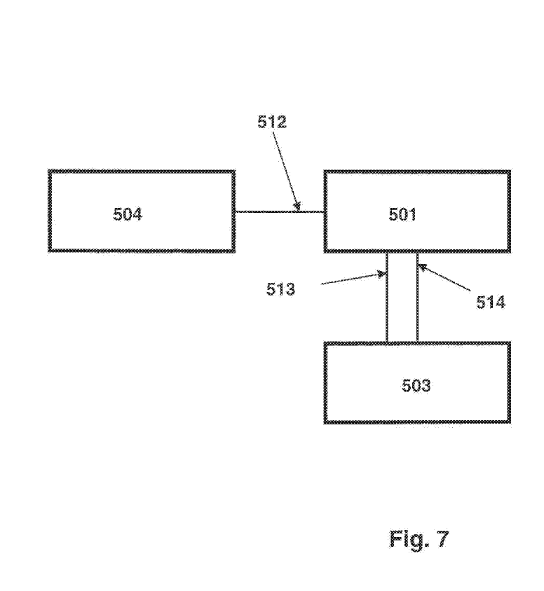

FIG. 7 illustrates a second exemplary embodiment of a network architecture comprising a smart card 504. The network comprises a first device 501, which is a RN and a further device 503, which is a DeNB. The RN 501 comprises a first interface 514, a second interface 512 and a third interface 513. The RN 501 is connected to the smart card 504 via the second interface 512. The RN 501 is connected with the DeNB 503 via a first interface 514 and via a third interface 513.

The second interface 512 may establish a binding via a secure channel. The first interface 514 may provide IPsec. The third interface 513 may provide a secure link.

Exemplary embodiments have been described for 3GPP technology. Similar solutions may be utilized in LTE technology, which is in particular a 3GPP technology, or in similar technologies.

In general, it is to be noted that respective functional elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Furthermore, method steps and functions likely to be implemented as software code portions and being run using a processor at one of the entities are software code independent and can be specified using any known or future developed programming language such as e.g. Java, C++, C, and Assembler. Method steps and/or devices or means likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

The network devices or network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

For the purpose of the present invention as described herein above, it should be noted that:
an access technology via which signaling is transferred to and from a network element or node may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable access networks may be any device, apparatus, unit or means by which a station, entity or other user equipment may connect to and/or utilize services offered by the access network; such services include, among others, data and/or (audio-) visual communication, data download etc.;
a user equipment may be any device, apparatus, unit or means by which a system user or subscriber may experience services from an access network, such as a mobile phone, personal digital assistant PDA, or computer;
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

Although described above mainly with respect to methods, procedures, an apparatus and modules thereof, it is to be understood that the present invention also covers a computer program products for implementing such methods or procedures and/or for operating such apparatuses or modules, as well as computer-readable (storage) media for storing such computer program products. The present invention also covers any conceivable combination of method steps and operations described above, and any conceivable combination of nodes, apparatuses and modules described above, as long as the above-described concepts of methodology and structural arrangement are applicable.

Furthermore, the network devices or network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

In this context, “first”, “second”, “third”, etc. in relation to devices or network devices or interfaces or security data may not be understood as hierarchy, it should be understood only to distinguish different devices or interfaces from each other.

It should be noted, that reference signs in the claims shall not be construed as limiting the scope of the claims.

### LIST OF ABBREVIATIONS

### 3GPP=Third Generation Partnership Project

### AAA=Authentication, Authorization, Accounting

### AKA=Authentication and Key Agreement

### AuC=Authentication Center

### AV=Authentication Vector

### CA=Certification Authority

### CK=Ciphering Key

### DeNB=Donor eNB

eNB=enhanced Node B

### EPS=Evolved Packet System

### GBA=Generic Bootstrapping Architecture

### GW=Gateway

### HSS=Home Subscriber Server

### IK=Integrity Key

### IKE=Internet Key Exchange

### IPsec=IP Security Protocol

### MME=Mobility Management Entity

### NAS=Non-Access Stratum

### OAM=Operation, Administration and Maintenance

### OCSP=Online Certificate Status Protocol

### PGW=Packet Data Network Gateway

### RN=Relay Node

### SGW=Serving Gateway

### TLS=Transport Layer Security

### UE=User Equipment

### UICC=Universal Integrated Circuit Card

USIM=Universal Subscriber Identity Module

1. A method for establishing a first secure and authorized connection between a smart card and a first device in a network, wherein the first device comprises a second secure connection to a second device, wherein the method comprises:
storing a first security data;
transferring the first security data between the first device and the second device;
providing the first security data at the first device;
establishing a binding between the smart card and the first device via the first secure and authorized connection utilizing the first security data;
authorizing the binding between the smart card and the first device; and
sending a second security data from the smart card to the first device via the first secure and authorized connection, whereas the second security data is usable for authentication of the first device to the network.

2. The method according to claim 1, wherein the security data is at least one security data from the group of data consisting of a pre-shared key, a certificate, a root certificate, certificate revocation data, authorization data, a serving network identity, a smart card identity, a network device identity, data generated from a run of EPS AKA a transformed key of a preexisting key, at least one parameter derived from a certificate and an authorization message.

3. The method according to claim 1, the method further comprising storing a list of keys and/or authorization data for the smart card on the second device installed within the network.

4. The method according to claim 1, the method further comprising
generating security data dynamically at the second device or at a third device, which third device is connected with the second device.

5. The method according to claim 1, the method further comprising
deriving the security data from parameters obtained during a run of EPS AKA authenticating the first device and/or from a device identity.

6. The method according to claim 1, the method further comprising
receiving a certificate or a root certificate at the first device originating from the second device.

7. The method according to claim 1, the method further comprising
providing integrity protection by digitally signing security data by a network device.

8. The method according to claim 1, the method further comprising:
the first device sending its own identity and/or the identity of the smart card to a fourth network device via the second device for authorization validation.

9. The method according to claim 1, the method further comprising:
the second device sending the identity of the first device and/or the identity of the smart card to a fourth network device for authorization validation.

10. The method according to claim 1, wherein the method is followed by an authentication or a re-authentication of the first device to the network using EPS AKA security data received over the secure and authorized connection.

11. The method according to claim 1, wherein the authentication is performed by IPsec.

12. The method according to claim 1, wherein a second device performs access control and/or platform validation of the first device to the network based on the result of at least one authentication or re-authentication.

13. Device in a network comprising
a first interface, second interface and a third interface,
wherein the first interface is adapted to send and/or receive security data,
wherein the second interface is adapted to establish a binding towards a smart card via a first secure and authorized connection,
wherein the third interface is adapted to establish a binding toward another device via a second secure connection.

14. Network device according to claim 13, wherein the network device is at least one network device selected from the group of devices consisting of a relay node (RN), an USIM in a UICC connected to an RN (USIM-RN), an eNB, a donor eNB, a MME, a MME-RN, a relay, a server, an OAM server, a OCSP server, a home subscriber server (HSS), a AAA server, an identity manager and a data repository.

15. A network device according to claim 13, comprising a first endpoint of a secure connection to the smart card and a second endpoint of a secure connection to a second network device, wherein the first endpoint and the second endpoint terminates in a same trusted environment in the network device.

16. Smart card within a network, wherein the smart card receives a device identity.

17. Smart card according to claim 16, wherein a transformation of security data stored in the smart card is performed using the device identity.

18. Smart Card according to claim 16, wherein the smart card performs a certificate status check using the device identity of the first device.

19. Computer program product comprising code portions for causing a network device, on which the computer program is executed, to carry out the method according to claim 1.

20. Computer-readable medium embodying the computer program product according to claim 19.
